(19) United States
(12) Patent Application Publication
(10) Pub. No.: US 2016/0353481 A1
(43) Pub. Date: Dec. 1, 2016

(54) Device and Method of Handling Communication Operation for Unlicensed Band

(71) Applicant: ACER INCORPORATED, New Taipei City (TW)

(72) Inventor: Hung-Yu Wei, New Taipei City (TW)

(21) Appl. No.: 15/158,601

(22) Filed: May 19, 2016

Related U.S. Application Data
(60) Provisional application No. 62/167,908, filed on May 29, 2015.

(51) Int. Cl. H04W 74/08; H04W 48/18; H04W 74/00; H04W 16/14

(52) U.S. Cl. CPC H04W 74/0808; H04W 16/14; H04W 48/18; H04W 74/006; H04W 84/042

(57) ABSTRACT

A base station of handling a communication operation for an unlicensed band comprise a storage unit for storing instructions and a processing means coupled to the storage unit. The processing means is configured to execute the instructions stored in the storage unit. The instructions comprise performing a carrier sensing in an unlicensed band to obtain a sensing result; configuring at least one channel of the unlicensed band to a communication device in a licensed band according to the sensing result; and performing a communication operation according to the sensing result.

### CROSS REFERENCE TO RELATED APPLICATIONS

This application claims the benefit of U.S. Provisional Application No. 62/167,908, filed on May 29, 2015, which is incorporated herein by reference.

### BACKGROUND OF THE INVENTION

1. Field of the Invention

The present invention relates to a communication device and a method used in a wireless communication system, and more particularly, to a communication device and a method of handling a communication operation for an unlicensed band.

2. Description of the Prior Art

A long-term evolution (LTE) system supporting the 3rd Generation Partnership Project (3GPP) Rel-8 standard and/or the 3GPP Rel-9 standard are developed by the 3GPP as a successor of the universal mobile telecommunication system (UMTS) for further enhancing performance of the UMTS to satisfy increasing needs of users. The LTE system includes a new radio interface and a new radio network architecture that provides high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple user equipments (UEs), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint (CoMP) transmissions/reception, uplink (UL) multiple-input multiple-output (UL-MIMO), etc. For a UE and an eNB to communicate with each other in the LTE-A system, the UE and the eNB must support standards developed for the LTE-A system, such as the 3GPP Rel-10 standard or later versions.

To ease network traffic load of a licensed band, communication operations of the LTE system can be offloaded to an unlicensed band. However, there may be other communication devices operated in the same unlicensed band. That is, communication operations (e.g., UL transmissions) performed by UEs in the LTE system may collide with communication operations (e.g., WiFi transmissions) performed by communication devices operating in the same unlicensed band. Accordingly, the UEs interfere with the communication devices. Performance improvement of the offloading is degraded.

Thus, how to perform a communication operation in the unlicensed band while reducing the interference caused to other communication devices is an important problem to be solved.

### SUMMARY OF THE INVENTION

A base station of handling a communication operation for an unlicensed band comprises a storage unit for storing instructions and a processing means coupled to the storage unit. The processing means is configured to execute the instructions stored in the storage unit. The instructions comprise performing a carrier sensing in an unlicensed band to obtain a sensing result; configuring at least one channel of the unlicensed band to a communication device in a licensed band according to the sensing result; and performing a communication operation according to the sensing result.

A base station of handling a communication operation for an unlicensed band comprises a storage unit for storing instructions and a processing means coupled to the storage unit. The processing means is configured to execute the instructions stored in the storage unit. The instructions comprise receiving at least one sensing result of an unlicensed band from at least one base station; configuring at least one channel of the unlicensed band to a communication device in a licensed band according to the at least one sensing result; and performing a communication operation according to the sensing result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a schematic diagram of carrier sensing and channel configuration according to an example of the present invention.

FIG. 5 is a schematic diagram of carrier sensing and channel configuration according to an example of the present invention.

FIG. 6 is a schematic diagram of carrier sensing and channel configuration according to an example of the present invention.

FIG. 7 is a flowchart of process according to an example of the present invention.

FIG. 8 is a schematic diagram of channel configuration according to an example of the present invention.

### DETAILED DESCRIPTION

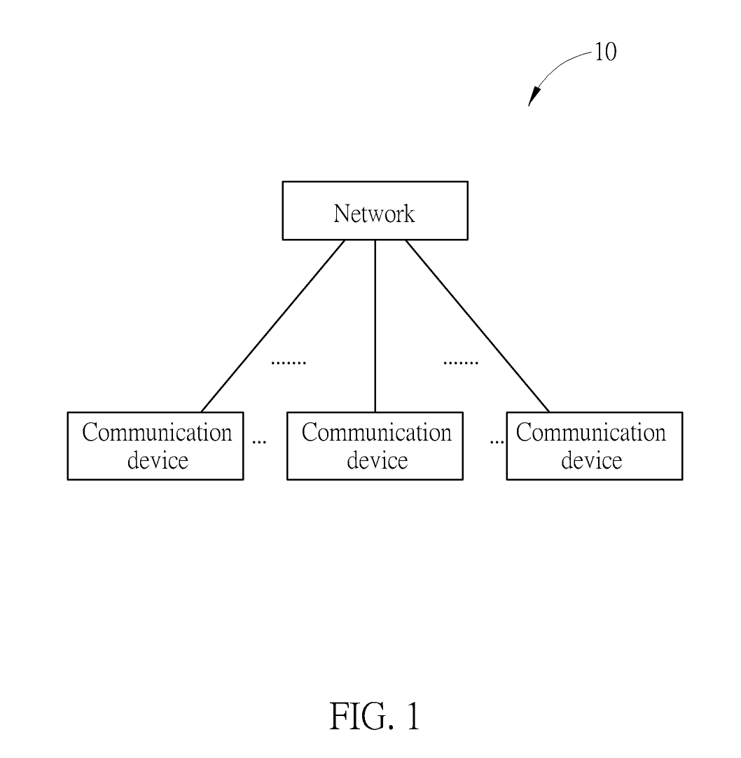

FIG. 1 is a schematic diagram of a wireless communication system 10 according to an example of the present invention. The wireless communication system 10 is briefly composed of a network and a plurality of communication devices. In FIG. 1, the network and the communication devices are simply utilized for illustrating the structure of the wireless communication system 10. Practically, the network may be a universal terrestrial radio access network (UTRAN) comprising at least one Node-B (NB) in a universal mobile telecommunications system (UMTS). In another example, the network may be an evolved UTRAN (E-UTRAN) comprising at least one evolved NB (eNB) and/or at least one relay in a long term evolution (LTE) system, a LTE-Advanced (LTE-A) system or an evolution of the LTE-A system.

Furthermore, the network may also include both the UTRAN/E-UTRAN and a core network, wherein the core network includes network entities such as Mobility Management Entity (MME), Serving Gateway (S-GW), Packet Data Network (PDN) Gateway (P-GW), Self-Organizing Networks (SON) server and/or Radio Network Controller (RNC), etc. In other words, after the network receives information transmitted by a communication device, the information may be processed only by the UTRAN/E-UTRAN and decisions corresponding to the information are made at the UTRAN/E-UTRAN. Alternatively, the UTRAN/E-UTRAN may forward the information to the core network, and the decisions corresponding to the information are made at the core network after the core network processes the information. In addition, the information can be processed by both the UTRAN/E-UTRAN and the core network, and the decisions are made after coordination and/or cooperation are performed by the UTRAN/E-UTRAN and the core network.

A communication device can be a user equipment (UE), a low cost device (e.g., machine type communication (MTC) device), a device-to-device (D2D) device, a mobile phone, a laptop, a tablet computer, an electronic book, a portable computer system, or combination thereof. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

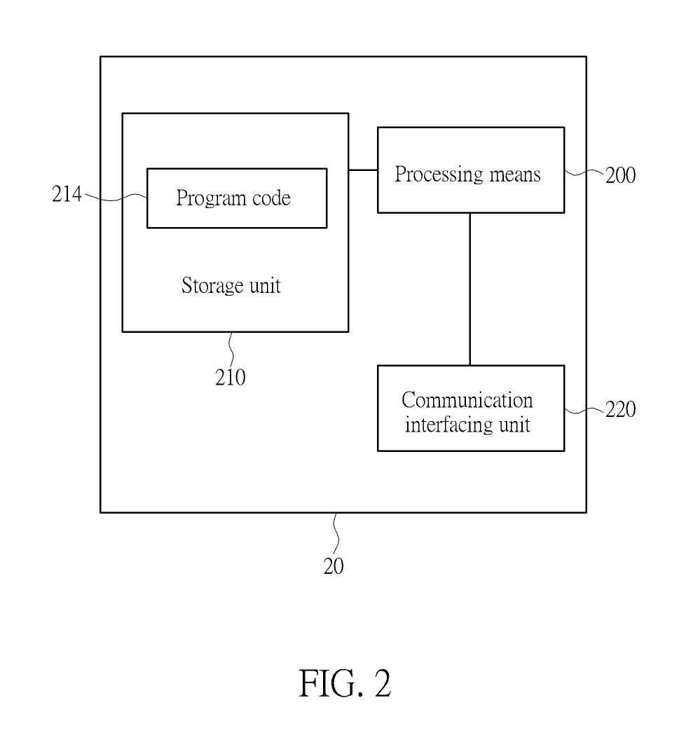

FIG. 2 is a schematic diagram of a communication device 20 according to an example of the present invention. The communication device 20 may be a communication device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage unit, non-transitory computer-readable medium (e.g., tangible media), etc. The communication interfacing unit 220 is preferably a transceiver and is used to transmit and receive signals (e.g., data, signals, messages and/or packets) according to processing results of the processing means 200.

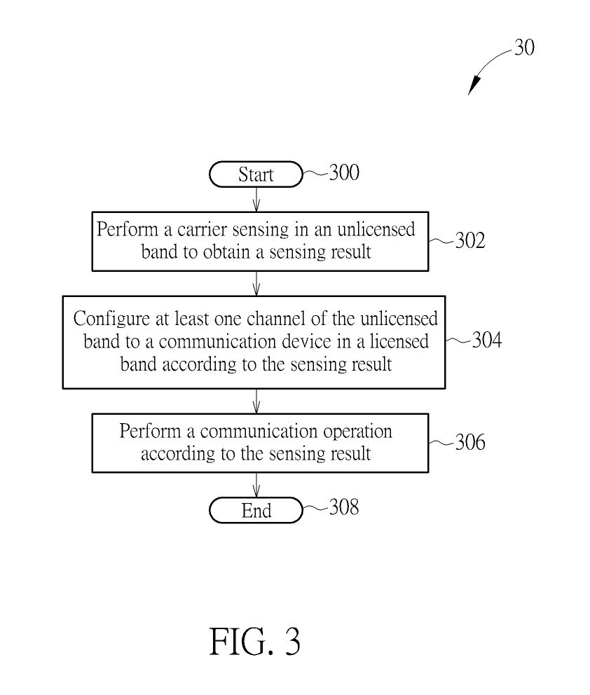

FIG. 3 is a flowchart of process 30 according to an example of the present invention. The process 30 may be utilized in a base station (e.g., eNB) of the network in FIG. 1, to handle a communication operation for an unlicensed band. The process 30 may be compiled into the program code 214 and includes the following steps:

Step 300: Start.

Step 302: Perform a carrier sensing in an unlicensed band to obtain a sensing result.

Step 304: Configure at least one channel of the unlicensed band to a communication device in a licensed band according to the sensing result.

Step 306: Perform a communication operation according to the sensing result.

Step 308: End.

According to the process 30, the base station may perform a carrier sensing in an unlicensed band to obtain a sensing result. The base station may configure at least one channel of the unlicensed band to a communication device in a licensed band according to the sensing result. Then, the based station may perform a communication operation according to the sensing result. That is, the base station may first perform the carrier sensing in the unlicensed band to obtain status of the unlicensed band, before performing the communication operation in the unlicensed band. Thus, the collision (or the interference) with other communication operations in the unlicensed band may be avoided (or reduced), when the base station performs the communication operation according to the sensing result. Thus, performances of the base station and the communication device operating in the unlicensed band system are improved.

Realization of the present invention is not limited to the above description. The following example may be applied to the process 30.

In one example, the carrier sensing may be performed via a narrow-band channel or a wide-band channel. In one example, the unlicensed band may be configured with at least one narrow-band channel and/or at least one wide-band channel. That is, the unlicensed band may include one or more narrow-band channels and one or more wide-band channels. The unlicensed band may include one or more narrow-band channels or one or more wide-band channels. In one example, the carrier sensing may be performed according to a first radio access technology (RAT), and the communication operation may be performed according to a second RAT. That is, the carrier sensing and the communication operation may be performed by using various RATs. Further, the first RAT and the second RAT may be an IEEE 802.11ac RAT, or an unlicensed band LTE RAT. For example, the carrier sensing may be performed according to the IEEE 802.11ac RAT, and the communication operation may be performed according to the unlicensed band LTE RAT, but is not limited herein.

In one example, the communication operation may include a transmission/reception of a data channel and/or a transmission/reception of a control channel. In one example, the base station may configure at least one channel (e.g., one or more channels) of the unlicensed band to a communication device by using a licensed band LTE RAT in a licensed band according to the sensing result. That is, the base station may perform the carrier sensing and the communication operation (e.g., transmission/reception) in the unlicensed band, and the base station may perform the configuration operation in the licensed band. The base station may perform the transmission/reception with the communication device via the configured at least one channel (e.g., channel with less interference or unoccupied channel), according to the sensing result. Thus, the collision (or the interference) with other communication operations in the unlicensed band may be avoided (or reduced), when the base station performs the communication operation according to the sensing result. As a result, performances of the base station and the communication device operating in the unlicensed band system are improved.

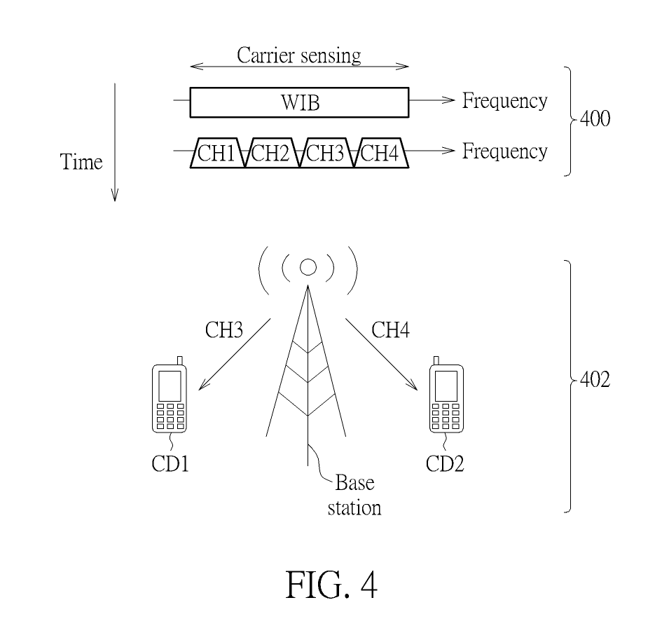

FIG. 4 is a schematic diagram of carrier sensing and channel configuration according to an example of the present invention. Two regions 400 and 402 are used for illustrating operations performed from different points of view. In the region 400, frequency and time are represented by a horizontal axis and a vertical axis, respectively. The unlicensed band may be used as a single wide-band channel WIB or narrow-band channels CH1-CH4. First, a base station may perform a carrier sensing in the wide-band channel WIB to obtain a sensing result of the unlicensed band, before performing a communication operation in the unlicensed band. The carrier sensing may be performed by at least one radio device with wide-band channel sensing capability of the based station. The carrier sensing may be performed by the base station according to an unlicensed band LTE RAT. Then, the base station may configure one of the narrow-band channels CH1-CH4 to a communication device for performing a communication operation in a licensed band according to the sensing result. That is, the base station may perform the carrier sensing in the wide-band channel WIB and perform the communication operation with the communication device in the narrow-band channel (e.g., channel CH3) according the sensing result. The configured channel may be a channel with less interference or an unoccupied channel. Note that widths of the channels CH1-CH4 may be the same or different.

In the region 402, according to the sensing result obtained in the region 400, the base station may know that the narrow-band channels CH1-CH2 are occupied or with more interference than the narrow-band channels CH3-CH4 for communication devices CD1-CD2. Thus, the base station may configure (or select) the narrow-band channels CH3-CH4 to the communication devices CD1-CD2 in the licensed band, respectively. Then, the base station may perform at least one transmission/reception with the communication devices CD1-CD2 via the narrow-band channels CH3-CH4, respectively. Thus, performances of the base station and the communication device operating in the unlicensed band system are improved.

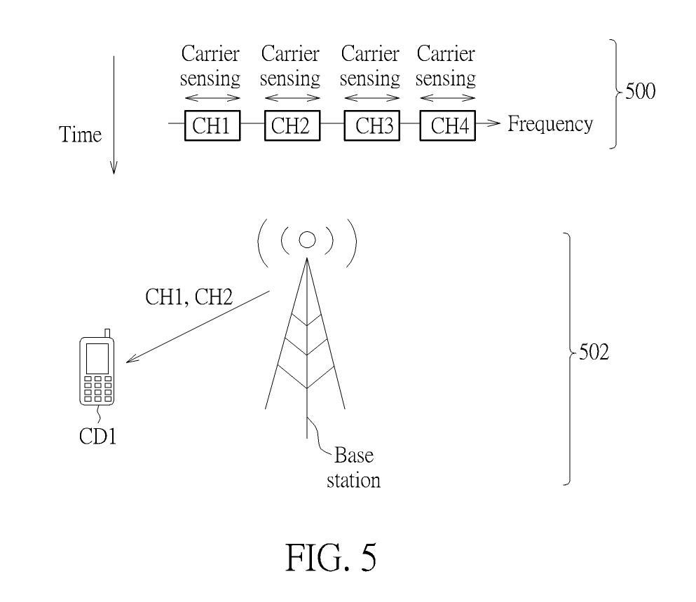

FIG. 5 is a schematic diagram of carrier sensing and channel configuration according to an example of the present invention. Two regions 500 and 502 are used for illustrating operations performed from different points of view. In the region 500, frequency and time are represented by a horizontal axis and a vertical axis, respectively. The unlicensed band may be respectively as narrow-band channels CH1-CH4. First, a base station may perform a carrier sensing in each of the narrow-band channels CH1-CH4 to obtain sensing results of the unlicensed band, before performing a communication operation in the unlicensed band. The carrier sensing may be performed by at least one radio device with narrow-band channel sensing capability of the based station. The base station may configure one or more of the narrow-band channels CH1-CH4 to a communication device for performing communication operation(s) in a licensed band according to the sensing results. That is, the base station may perform the carrier sensing in the narrow-band channels CH1-CH4 and perform the communication operations with the communication device in the one or more narrow-band channel (e.g., channels CH1-CH2) according to the sensing results. Note that widths of the channels CH1-CH4 may be the same or different.

In the region 502, according to the sensing results obtained in the region 500, the base station may know that the narrow-band channels CH3-CH4 are occupied or with more interference than the narrow-band channels CH1-CH2 for a communication device CD1. Thus, the base station may configure (or select) the narrow-band channels CH1-CH2 to the communication device CD1 in the licensed band. Then, the base station may perform at least one transmission/reception with the communication devices CD1 via the narrow-band channels CH1-CH2. Thus, performances of the base station and the communication device operating in the unlicensed band system are improved.

On the other hand, there may be other base station(s) which already operate in the unlicensed band. In one example, the base station may receive at least one sensing result of the unlicensed band from at least one base station. That is, the base station may obtain more channel information (e.g., average usage time ratio) of the unlicensed band from the at least one based station. Further, the base station may configure at least one channel (e.g., one or more channels) of the unlicensed band to a communication device by using a licensed band LTE RAT in a licensed band according to the sensing result and the at least one sensing result. That is, the base station may receive the at least one sensing result and perform the communication operation (e.g., transmission/reception) in the unlicensed band, and the base station may perform the configuration operation in the licensed band. In one example, the communication operation may be performed according to the sensing result and the at least one sensing result. That is, the base station may perform the transmission/reception with the communication device via the configured at least one channel (e.g., channel with less interference or unoccupied channel) according to the sensing result and the at least one sensing result. Thus, the collision (or the interference) with the other communication operations in the unlicensed band may be avoided (or reduced), when the base station performs the communication operation according to the sensing result and the least one sensing result. Thus, performances of the base station and the communication device operating in the unlicensed band system are improved.

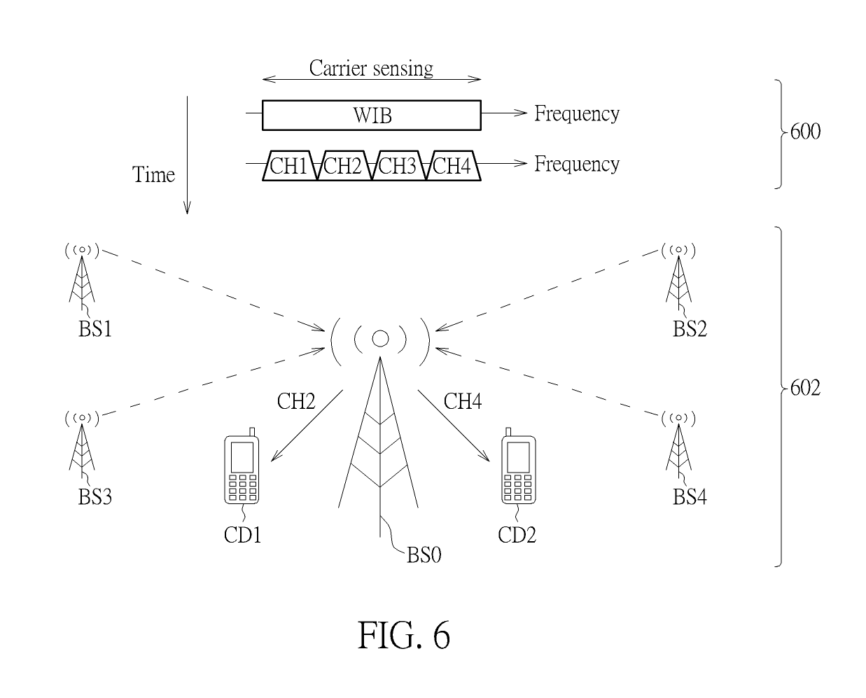

FIG. 6 is a schematic diagram of carrier sensing and channel configuration according to an example of the present invention. Two regions 600 and 602 are used for illustrating operations performed from different points of view. In the region 600, frequency and time are represented by a horizontal axis and a vertical axis, respectively. The unlicensed band may be used as a single wide-band channel WIB or narrow-band channels CH1-CH4. First, abase station BS0 may perform a carrier sensing in the wide-band channel WIB to obtain a sensing result of the unlicensed band, before performing a communication operation in the unlicensed band. The carrier sensing may be performed by at least one radio device with wide-band channel sensing capability of the based station BS0. The carrier sensing may be performed by the base station BS0 according to an unlicensed band LTE RAT. In addition, there may be other base stations BS1-BS4 operated in the same unlicensed band as shown in the region 602. The base station BS0 may receive at least one sensing result of the unlicensed band from the base stations BS1-BS4. Then, the base station BS0 may configure one of the narrow-band channels CH1-CH4 to a communication device in the wide-band channel WIB in a licensed band according to the sensing result and the at least one sensing result. That is, the base station BS0 may perform the carrier sensing in the wide-channel channel WIB and receive the at least one sensing result from the base stations BS1-BS4 in the unlicensed band. The base station BS0 may perform the communication operation with the communication device in the narrow-band channel (e.g., channel CH3) according to the sensing result and the at least one sensing result. The configured channel may be a channel with less interference or an unoccupied channel. Note that, widths of the narrow-band channels CH1-CH4 may be the same or different.

In the region 602, according to the sensing result obtained in the region 600 and the at least one sensing result from the base stations BS1-BS4, the base station BS0 may know that the narrow-band channels CH1 and CH3 are occupied or with more interference than the narrow-band channels CH2 and CH4. Thus, the base station BS0 may configure (or select) the narrow-band channels CH2 and CH4 to communication devices CD1-CD2 in the licensed band, respectively. Then, the base station may perform at least one transmission/reception with the communication devices CD1-CD2 via the narrow-band channels CH2 and CH4, respectively. Thus, performances of the base station and the communication device operating in the unlicensed band system are improved.

AS can be seen, the base station may configure at least one channel for performing communication operations in the licensed band, according to a sensing result obtained by itself and/or at least one sensing result received from other base station(s) in the unlicensed band. Thus, the collision (or the interference) with other communication operations in the unlicensed band may be avoided (or reduced), when the base station performs the communication operations via the configured at least one channel. Thus, performances of the base station and the communication device operating in the unlicensed band system are improved.

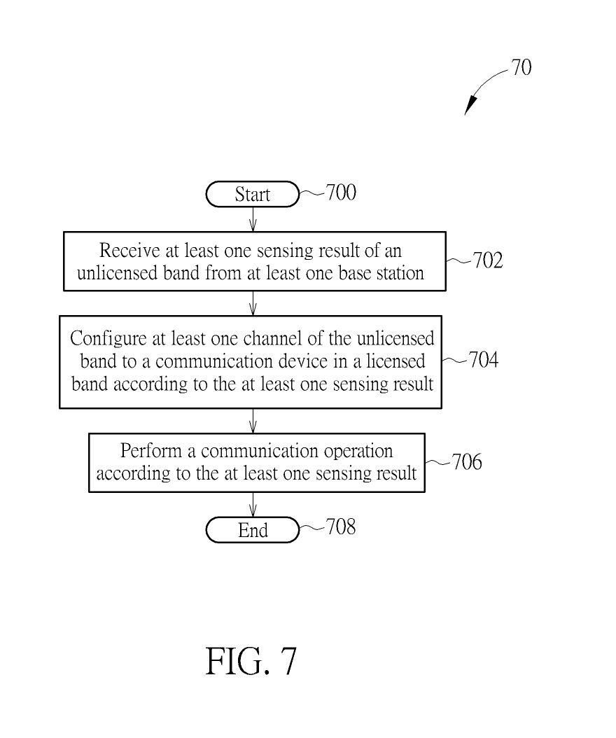

FIG. 7 is a flowchart of process 70 according to an example of the present invention. The process 70 may be utilized in a base station (e.g., eNB) of the network in FIG. 1, to handle a communication operation for an unlicensed band. The process 70 may be compiled into the program code 214 and includes the following steps:

Step 700: Start.

Step 702: Receive at least one sensing result of an unlicensed band from at least one base station.

Step 704: Configure at least one channel of the unlicensed band to a communication device in a licensed band according to the at least one sensing result.

Step 706: Perform a communication operation according to the at least one sensing result.

Step 708: End.

According to the process 70, the base station may receive at least one sensing result of an unlicensed band from at least one base station. The base station may configure at least one channel of the unlicensed band to a communication device in a licensed band according to the at least one sensing result. Then, the based station may perform a communication operation according to the at least one sensing result. That is, the base station may receive the at least one sensing result of the unlicensed band from the at least one base station, before performing the communication operation in the unlicensed band. Thus, the collision (or the interference) with the other communication operations in the unlicensed band may be avoided (or reduced), when the base station performs the communication operation according to the at least one sensing result. Thus, performances of the base station and the communication device operating in the unlicensed band system are improved.

Realization of the present invention is not limited to the above description. The following example may be applied to the process 70.

In one example, the unlicensed band may be configured with at least one narrow-band channel and/or at least one wide-band channel That is, the unlicensed band may include one or more narrow-band channels and one or more wide-band channels. The unlicensed band may include one or more narrow-band channels or one or more wide-band channels. In one example, the communication operation may be performed according to a RAT. Further, the RAT may be an IEEE 802.11ac RAT, or an unlicensed band LTE RAT, but is not limited herein.

In one example, the communication operation may include a transmission/reception of a data channel and/or a transmission/reception of a control channel. In one example, the base station may configure at least one channel (e.g., one or more channels) of the unlicensed band to a communication device by using a licensed band LTE RAT in a licensed band according to the at least one sensing result. That is, the base station may receive the at least one sensing result and perform the communication operation (e.g., transmission/reception) in the unlicensed band, and the base station may perform the configuration operation in the licensed band. The base station may perform the transmission/reception with the communication device via the configured at least one channel (e.g., channel with less interference or unoccupied channel), according to the received at least one sensing result. Thus, the collision (or the interference) with other communication operations in the unlicensed band may be avoided (or reduced), when the base station performs the communication operation according to the at least one sensing result. As a result, performances of the base station and the communication device operating in the unlicensed band system are improved.

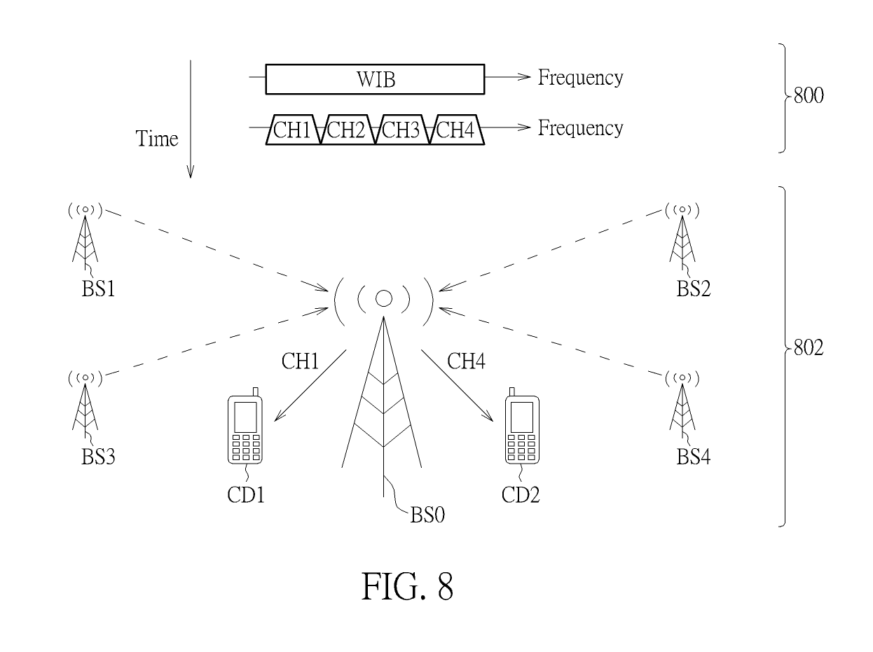

FIG. 8 is a schematic diagram of channel configuration according to an example of the present invention. Two regions 800 and 802 are used for illustrating operations performed from different points of view. In the region 800, frequency and time are represented by a horizontal axis and a vertical axis, respectively. The unlicensed band may be used as a single wide-band channel WIB or narrow-band channels CH1-CH4. Abase station BS0 may not need to perform a carrier sensing by itself in the present example. In the region 802, there may be other base stations BS1-BS4 operated in the same unlicensed band. The base station BS0 may receive at least one sensing result of the wide-band channel WIB from the base stations BS1-BS4 in the unlicensed band. That is, the base station BS0 may obtain status of the wide-band channel WIB via receiving the at least one sensing result from the other base stations BS1-BS4. Then, the base station BS0 may configure one of the narrow-band channels CH1-CH4 to a communication device in a licensed band according to the received sensing result (s). The configured channel may be a channel with less interference or an unoccupied channel. In addition, widths of the narrow-band channels CH1-CH4 may be the same or different.

In the region 802, according to the at least one sensing result received from the base stations BS1-BS4 in the unlicensed band, the base station BS0 may know that the narrow-band channels CH2 and CH3 are occupied or with more interference than the narrow-band channels CH1 and CH4. Thus, the base station may configure (or select) the narrow-band channels CH1 and CH4 to communication devices CD1-CD2 in the licensed band, respectively. Then, the base station may perform at least one transmission/reception with the communication devices CD1-CD2 via the narrow-band channels CH1 and CH4, respectively. Thus, performances of the base station and the communication device operating in the unlicensed band system are improved.

AS can be seen, the base station may configure at least one channel for performing communication operations in the licensed band according to the at least one sensing result received from other base station(s) in the unlicensed band without performing the carrier sensing by itself. Thus, the collision (or the interference) with other communication operations in the unlicensed band may be avoided (or reduced), when the base station performs the communication operations via the configured at least one channel. Thus, performances of the base station and the communication device operating in the unlicensed band system are improved.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20.

Examples of the hardware may include analog circuit(s), digital circuit (s) and/or mixed circuit (s). For example, the hardware may include ASIC(s), field programmable gate array(s) (FPGA(s)), programmable logic device(s), coupled hardware components or combination thereof. In another example, the hardware may include general-purpose processor(s), microprocessor(s), controller(s), digital signal processor(s) (DSP(s)) or combination thereof.

Examples of the software may include set(s) of codes, set(s) of instructions and/or set(s) of functions retained (e.g., stored) in a storage unit, e.g., a computer-readable medium. The computer-readable medium may include SIM, ROM, flash memory, RAM, CD-ROM/DVD-ROM/BD-ROM, magnetic tape, hard disk, optical data storage device, non-volatile storage unit, or combination thereof. The computer-readable medium (e.g., storage unit) may be coupled to at least one processor internally (e.g., integrated) or externally (e.g., separated). The at least one processor which may include one or more modules may (e.g., be configured to) execute the software in the computer-readable medium. The set(s) of codes, the set(s) of instructions and/or the set(s) of functions may cause the at least one processor, the module(s), the hardware and/or the electronic system to perform the related steps.

Examples of the electronic system may include a system on chip (SoC), system in package (SiP), a computer on module (CoM), a computer program product, an apparatus, a mobile phone, a laptop, a tablet computer, an electronic book or a portable computer system, and the communication device 20.

To sum up, the present invention provides a device and a method for handling a communication operation for an unlicensed band. The collision (or the interference) with other communication operations in the unlicensed band may be avoided (or reduced), when the base station performs the communication operation in the unlicensed band according to a sensing result obtained by itself and/or at least one sensing result received from other base station(s). Thus, performances of the base station and the communication device operating in the unlicensed band system are improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A base station of handling a communication operation for an unlicensed band, comprising:
a storage unit, for storing instructions of:
performing a carrier sensing in an unlicensed band to obtain a sensing result;
configuring at least one channel of the unlicensed band to a communication device in a licensed band according to the sensing result; and
performing a communication operation according to the sensing result; and
a processing means, coupled to the storage unit, configured to execute the instructions stored in the storage unit.

2. The base station of claim 1, wherein the carrier sensing is performed via a narrow-band channel or a wide-band channel.

3. The base station of claim 1, wherein the unlicensed band is configured with at least one narrow-band channel and/or at least one wide-band channel.

4. The base station of claim 1, wherein the carrier sensing is performed according to a first radio access technology (RAT), and the communication operation is performed according to a second RAT.

5. The base station of claim 4, wherein the first RAT and the second RAT are an IEEE 802.11ac RAT, or an unlicensed band LTE RAT.

6. The base station of claim 1, wherein the communication operation comprises a transmission/reception of a data channel and/or a transmission/reception of a control channel.

7. The base station of claim 1, the storage unit further stores an instruction of:
receiving at least one sensing result of the unlicensed band from at least one base station.

8. The base station of claim 7, the storage unit further stores an instruction of:
configuring at least one channel of the unlicensed band to a communication device in a licensed band according to the sensing result and the at least one sensing result.

9. The base station of claim 7, wherein the communication operation is performed according to the sensing result and the at least one sensing result.

10. A base station of handling a communication operation for an unlicensed band, comprising:
a storage unit, for storing instructions of:
receiving at least one sensing result of an unlicensed band from at least one base station;
configuring at least one channel of the unlicensed band to a communication device in a licensed band according to the at least one sensing result; and
performing a communication operation according to the at least one sensing result; and
a processing means, coupled to the storage unit, configured to execute the instructions stored in the storage unit.

11. The base station of claim 10, wherein the unlicensed band is configured with at least one narrow-band channel and/or at least one wide-band channel.

12. The base station of claim 10, wherein the communication operation is performed according to a radio access technology (RAT).

13. The base station of claim 12, wherein the RAT comprises an IEEE 802.11ac RAT, or an unlicensed band LTE RAT.

14. The base station of claim 10, wherein the communication operation comprises a transmission/reception of a data channel and/or a transmission/reception of a control channel.
